(19) United States
(12) Patent Application Publication
(10) Pub. No.: US 2006/0168624 A1
(43) Pub. Date: Jul. 27, 2006

(54) Method and system for delivering enhanced TV content

(76) Inventors: John Carney, Corte Madera, CA (US); David de Andrade, Fairfax, CA (US); Greg Thomson, Mill Valley, CA (US); David Brandyberry, San Rafael, CA (US); Matt Marenghi, San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/285,656

(22) Filed: Nov. 22, 2005

Related U.S. Application Data
(60) Provisional application No. 60/630,510, filed on Nov. 22, 2004.

(51) Int. Cl. H04N 5/445; G06F 13/00; G06F 17/00; G06F 15/00; G06F 3/00; G06F 17/24; G06F 17/21; H04N 7/173

(52) U.S. Cl. 725/51; 725/110; 725/39; 725/109; 715/513

(57) ABSTRACT

A method and system for delivering enhanced TV (eTV) content allows content producers to author eTV content and deliver the eTV content over an IP network to an eTV application server at a cable headend. A network server, for example, operated by a broadcast network, communicates broadcast program scheduling information to the eTV application server over an IP network. Prior to, and during, the broadcast of a particular program, the eTV application server makes the eTV application content available to a set-top-box via an out-of-band data carousel or via IP multicast. A client-side application engine, executing on the set-top-box, receives the scheduling information and the eTV application content from the data carousel or IP multicast, and launches the eTV application content, based on the scheduling information and the channel being viewed, or tuned, by the viewer.

### RELATED APPLICATIONS

The present application claims the priority benefit and is a NONPROVISIONAL of U.S. Provisional Patent Application 60/630,510 filed Nov. 22, 2004, incorporated herein by reference.

### FIELD OF THE INVENTION

The present invention relates generally to interactive TV. More particularly, the present invention relates to a method and system for delivering enhanced, interactive content in a live, or recorded, television broadcast stream.

### BACKGROUND OF THE INVENTION

Traditionally, watching a television program has been a passive experience. For example, with a traditional television broadcast program, the viewer watches the television program without responding or initiating any action in return. In contrast, “surfing” the Internet and playing video games are interactive endeavors. With the Internet and video games, the viewer is an active participant and the outcome is often dependent upon action taken by the viewer.

The television industry has been increasingly investing in ways to make the television viewing experience more interactive, similar to surfing the World Wide Web, or playing a video game. Today, interactive television (iTV) is currently available in varying forms. One variety of iTV is commonly referred to as enhanced TV, or eTV. Enhanced TV broadcasting provides interactive content linked to video programming. For example, with enhanced TV broadcasting, a user may be able to 1) request information related to products that are being advertised, 2) access additional information related to programs being viewed, such as player and/or team statistics during a live sporting event, and/or 3) interact with a television broadcast program, such as a game show.

There are a multitude of problems related to managing and delivering content for enhanced TV.

### SUMMARY OF THE INVENTION

In various embodiments the present invention provides methods and systems in which an eTV application (e.g., a voting and/or polling application) for a program to be broadcast over a distribution network, a corresponding playlist for the eTV application and a programming schedule for the distribution network are delivered to a server in advance of the broadcast time of the program and using Internet protocol (IP). The playlist specifies a list of events to be loaded by an application engine resident on a client device when executing the eTV application. The events of the playlist include identifiers that enable the eTV application to synchronize application trigger events to program events associated with the program.

Prior to broadcast of the program and according to the programming schedule, a playlist directory, the eTV application and the playlist are distributed to client devices by uploading from the server to an out-of-band data carousel, or by an IP multicast distribution mechanism. The application and playlist are accessible by the client device via the out-of-band carousel or IP multicast independently from a broadcast stream including packets which make up the program.

At the client device the playlist directory, the eTV application and the playlist are received form the out-of-band carousel or IP multicast connection, and, so long as the client device is tuned to the broadcast of the program associated with the eTV application, the application engine processes the events as specified in the playlist (e.g., at specified times and/or as specified according to certain time codes).

In various embodiments, the eTV application may be an XML file, for example including application layout information, application logic, image resources, and/or program-specific information. Likewise, the programming schedule may be an XML file describing a program market, date, time, channel and application identifier for the eTV application. Prior to being uploaded, the programming schedule and/or the eTV application may be validated.

The playlist may include a list of application events scheduled to occur during broadcast of the program. One such event may cause the application engine of the client device to display information. Alternatively, or in addition, one such event of the playlist may cause the application engine of the client device to prompt a viewer to make a selection. The playlist may be made up of XML data. Timing of playlist events may be adjusted in response to synchronization information received at the server.

In some embodiments of the present invention, viewer input associated with one of the events of the playlist may be communicated from the client device to the server. Such viewer input may include a selection from a list.

### BRIEF DESCRIPTION OF THE DRAWINGS

The present invention is illustrated by way of example, and not by way of limitation, in the figures of the accompanying drawings, in which like references indicate similar elements, and in which:

FIG. 1 illustrates a system, according to one embodiment of the present invention, for delivering enhanced TV content; and

FIG. 2 illustrates a method, according to one embodiment of the invention, for delivering enhanced TV content.

### DETAILED DESCRIPTION

A method and system for delivering enhanced TV content are described. In the following description, for purposes of explanation, numerous specific details are set forth in order to provide a thorough understanding of the present invention. It will be evident, however, to one skilled in the art that the present invention may be practiced without these specific details. The following terms are used throughout the document in connection with this description of the present invention:

Application Data is a collection of text and binary files. Application data is used to invoke specific application functions via the client-side application engine, such as drawing routines, etc. The application data also includes business rules, and OSD (on screen display) images.

Application Engine The eTV application client is the application engine that runs eTV applications. It is resident on the set-top device and is always running—in either background or foreground mode. In either mode the application client is capable of monitoring a schedule to compare against the current channel and STB time and launch eTV applications based on that schedule. It therefore does not require broadcast stream application signaling (such as AIT) for launching applications. The application client makes use of delivered text and binary files.

Application Signaling describes the mechanism by which an application, such as an eTV application related to a broadcast program, is launched.

eTV Schedule A schedule comprising entries for time, channel, and app to load.

Program Synchronization describes the mechanism by which program events, such as events in a broadcast program, are synchronized with events in an application related to the broadcast. Program synchronization includes carriage of signaling events in streams related to the broadcast that provide timing information for the program.

Playlist A playlist is a list of triggers (or events) that are loaded by a set-top box (or other client) application independently from the broadcast stream of the service (except for an optional case where the broadcast stream is used solely as a file delivery mechanism). The individual elements of the list may have program time codes or other identifiers that enable the application to synchronize application trigger events to program events associated with the broadcast program. The application requires program synchronization support to synchronize playlist events with program events.

Playlist Directory A playlist directory is an aggregation of eTV schedules for the current period into a single data file.

Trigger A trigger is an event that may cause a change in the behavior of an eTV application that registers interest in such events. Triggers may come from many sources, for example, the broadcast stream or IP connection, or may be generated from other data (such as the system clock). The trigger may include a reference to time, which may be absolute (UTC), or relative to some other event, relative to the NPT (normal play time) of a media stream. It also can carry some semantically significant payload in order to affect changes in an application based on information not available at the time an application was written. There are two types of triggers:
a. Do-it-now triggers are executed when received. Thus, do-it-now triggers are ‘self-synchronizing’.
b. Do-it-then triggers include a time code to indicate when the trigger should be executed relative to the program. Thus, do-it-then triggers require a mechanism for synchronization with program events.

Utilizing one embodiment of the present invention, a cable TV provider may provide a wide variety of enhanced TV applications, such as voting and polling applications, in conjunction with broadcast programming. One embodiment of the present invention may be compatible with a wide variety of existing system components, such as middleware, eTV content publishing software, and other software and hardware platforms, including Liberate 3.4, MSTV 1.9 and Guideworks “JV1.” Consequently, the present invention is advantageous over previous systems and methods in part because it may be implemented at a low-cost, and with minimal complexity. In many cases, the present invention may be implemented without unnecessary investment in additional hardware and software. Moreover, the present invention may be implemented to use some of the same client and server software applications already in use to deploy other strategic applications, including virtual channels, video on demand services, information services, local content, advertising and promotions, as well as others.

Although the present invention may be implemented to deploy a wide variety of enhanced TV content and applications, the present invention may be particularly useful for deploying polling and voting applications. For example, one embodiment of the invention will make possible a wide variety of polling and voting applications to be used in conjunction with reality TV shows, sporting events, awards shows, news programs, talk shows, and other broadcast programs. For example, when used in conjunction with a reality TV program, a voting application may prompt viewers to vote for a favorite contestant or to decide on a contest winner. Alternatively, a polling application may allow viewers of a sporting event to vote for the most valuable player of a particular game, or view player or game statistics during a live broadcast of the sporting event.

As will be described in greater detail below, one embodiment of the invention utilizes a client-side application engine executing on a set top box (STB) to present, or display, enhanced TV content. In one embodiment, the enhanced TV content is delivered as a “playlist” to the STB via an out-of-band (OOB) data carousel. For example, the playlist may include a list of application events that are scheduled to take place within the application during certain portions of the corresponding broadcast program. For example, an event in the playlist may cause the client-side application engine to display information, or prompt the user to make a selection, at a particular point in time during a particular broadcast program. The present invention differs from existing solutions in that the client-side application engine exists, and executes, on the STB while only application data is delivered to the STB via a data carousel.

According to one embodiment of the invention, an enhanced TV application may include, but not necessarily be limited to the following components:

Application XML and Resources—The client-side application engine may receive XML data consistent with one or more XML schemas. For example, the XML schemas may define the application data requirements and resources for a particular application. Accordingly, the XML data may include programming and application data such as: the application layout, application logic, image resources, and/or episodic or program specific data.

Episode or Program Specific Playlist—The episode or program specific playlist generally will include application data related to the specific broadcast program. For example, the episode or program specific playlist may include, but not be limited to a schedule of events, which are to be executed, or displayed, during the broadcast program associated with the particular playlist. In one embodiment, the playlist may be formatted and delivered as XML data.

Playlist Directory—The playlist directory includes a schedule of all possible episode or program specific playlists for a particular system over a given time period. For example, the schedule may include scheduling information about the individual playlists, scheduling information for the particular broadcast programs to which each playlist is associated, including the particular time, or time range, for which a broadcast program may potentially be active, and therefore a playlist valid.

STB clock—The STB clock is an internal system clock utilized as a reference clock, for example, to synchronize playlists, or playlist events, with their corresponding broadcast programs. For example, the schedule of events in a playlist may include references to the STB clock in order to properly synchronize the playlist events with their corresponding broadcast programs.

Application Data Delivery Mechanism—In one embodiment, the application delivery mechanism is the means by which the application, episode or program specific playlists, playlist directory, and synchronization messages are delivered to the STB. For example, in one embodiment, the application delivery mechanism is an out-of-band data broadcast carousel server located in the cable headend.

Application Engine—The application engine is a client-side application that executes on the STB. In one embodiment, the application engine executes (e.g., reads and interprets) application data received via the application data distribution mechanism (e.g., the data carousel). In addition, in one embodiment, the application engine may include a “playlist listener” that periodically (e.g., every minute) checks the playlist directory file on the data carousel for discovery of program specific playlists that may be valid.

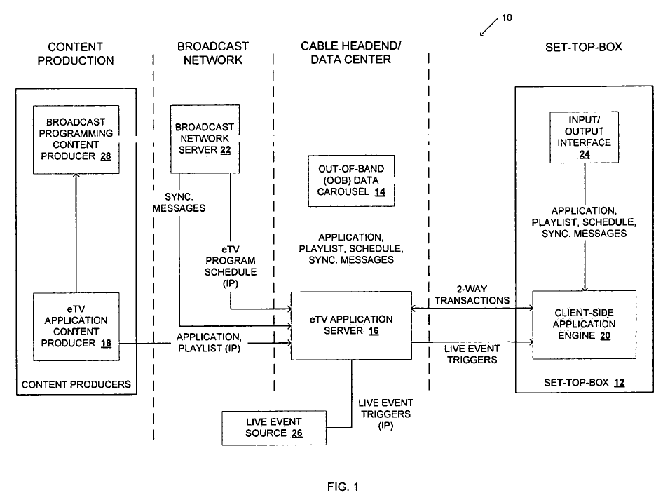

FIG. 1 illustrates several of the various components included in a system 10, according to one embodiment of the present invention, for delivering enhanced TV content. As illustrated in FIG. 1, the several components have been divided (e.g., by the parallel dotted lines) according to their location and function. For example, the STB 10 is generally located at the customer premises and is operated and controlled by the customer or viewer. The cable headend/data-center, operated and controlled by the cable provider, is where the out-of-band data carousel 14 and eTV application server 16 are located.

Referring again to FIG. 1, according to one embodiment of the invention, an eTV application content producer 18 generates an enhanced TV application and its associated playlist for a corresponding broadcast program, and delivers the enhanced TV application to the eTV application server 16 residing at the cable headend. For example, in one embodiment, the content producer 18 may utilize an eTV content publishing software application that automatically generates enhanced TV application data consistent with a predefined XML schema that is utilized by one, or both of, the eTV application server 16 and the client-side application engine 20 executing on the STB 12. One advantage of the present invention is that there is minimal impact on the existing TV production, origination and transmission processes that occur, in part, at the broadcast programming content producer 28.

In one embodiment, an eTV application may include one or more files of XML data, including, but not limited to application and resource data, and playlist data. In addition, according to one embodiment, the application and its associated playlist may be delivered and may be updated at any time prior to the broadcast of the program to which the application is associated. Furthermore, in one embodiment of the invention, the application and playlist are delivered over a conventional network, for example, using a network based on standard networking protocols, such as the Internet Protocol (IP) suite. In addition, in one embodiment of the invention, the eTV application server 16 may perform a validation operation on the eTV application data, for example, to ensure that all the necessary data for the application has been provided and to ensure that the data has been properly formatted

In one embodiment of the invention, a network server 22 operated by the broadcast network may deliver a broadcast program schedule to the eTV application server 16 for one or more broadcast programs and/or corresponding eTV applications. For example, the broadcast network server 22, or some other computing device operated by the broadcast network, may communicate program scheduling information to the eTV application server 16 over a network. For example, in one embodiment of the invention, the scheduling information may be an XML file including data related to the market, date/time, channel call letters and application identifier for each eTV application. Again, the broadcast network server 22 may communicate with the eTV application server 16 via standard networking protocols, such as IP. The eTV application server 16 may analyze and organize the program scheduling information received from one or more broadcast networks in order to build, or develop, a playlist directory.

According to one embodiment of the invention, based on the received programming schedules, the eTV application server 16 at the cable headend inserts the necessary data making up the application (e.g., application and resource data, program specific playlist, and playlist directory) into an out-of-band data carousel 14. The data carousel 14 broadcasts the data, which is received at the input/output interface 24 of the STB 12.

In one embodiment of the invention, the STB 12 executes a client-side application engine 20, which loads the eTV application data from the data carousel 14. For example, based on the playlist directory, if and when the viewer tunes a program having an associated eTV application, the client-side application engine 20 will “execute” events from the program specific playlist. In one embodiment of the invention, the client-side application engine 20 “executes” the events from the program specific playlist by coordinating playlist events with the STB clock.

According to one embodiment of the invention, when a user responds to a playlist event, for example, by making a selection from a list, or menu, of choices displayed on the TV display, the information may be communicated back to the eTV application server utilizing a 2-way return channel. For example, a 2-way return channel may be used to communicate 2-way request and response packets between the STB and the eTV application server 16.

In one embodiment of the invention, the broadcast network may administer control messages (e.g., synchronization messages) to uniformly adjust the program scheduling information. For example, the broadcast network server 22 may communicate synchronization messages (e.g., via an IP network) to the eTV application server 16 to adjust programming schedules. The eTV application server 16 may receive the synchronization messages, adjust the playlist directory or program specific playlist information accordingly, and then broadcast the adjusted information via the out-of-band data carousel 14. This may be required, for example, if a regularly scheduled program is necessarily interrupted by a breaking news event. Accordingly, when the eTV application server 16 adjusts the playlist directory information, or the program specific playlist, events are correctly “executed” at the proper time. Similarly, control messages (e.g., synchronization messages) may be communicated to the eTV application server 16 to support live programming events 26 (e.g., sporting events), or market dependent behavior, such as for example, the ability for major ABC affiliates in the mountain time-zone to set the mountain minute.

The following table (TABLE 1) illustrates the various end-to-end delivery mechanisms utilized in one embodiment of the present invention:

TABLE 1

| | Delivery to | |
|---|---|---|
| Component | App Server | Delivery to Client |
| Application Engine | N/A | Flashed on client (load on boot) |
| Application XML | IP | OOB Carousel or IP multicast |
| Playlist | IP | OOB Carousel or IP multicast |
| Playlist directory | IP | OOB Carousel or IP multicast |
| eTV Schedule | IP | N/A |
| Sync messages | IP | OOB Carousel or broadcast/multicast |
| | | messages |

Similarly, the following table (TABLE 2) provides a brief explanation of the control signals used in one embodiment of the invention:

TABLE 2

| Control | Server | Client |
|---|---|---|
| Message to load | IP message on | N/A |
| App on Carousel | time, or by | |
| | Schedule | |
| Message to load | | Schedule monitored on client along |
| App on Client | | with current channel to launch on |
| | | time and on channel. The client |
| | | engine checks the schedule at a |
| | | configurable frequency (e.g. once |
| | | every minute) to determine whether |
| | | an application enhancement is |
| | | required to launch |
| Clock sync | | Client uses set-top clock for sync |
| Synch events | | Client uses its clock to fire |
| | | events based on playlist media |
| | | time reference |

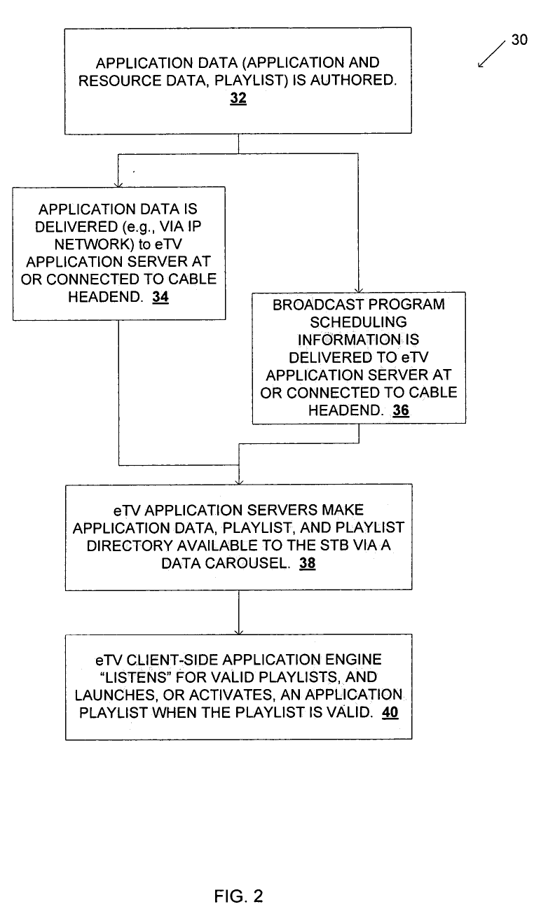

FIG. 2 illustrates a method 30, according to one embodiment of the invention, for delivering eTV content. As illustrated in FIG. 2, at operation 32, eTV content for an eTV application is generated. For example, in one embodiment of the invention, existing content publishing software may be utilized to author eTV applications. In addition, in one embodiment, the content publishing software automatically generates one or more XML files containing the application data and playlist, according to a predefined XML schema.

At operation 34, the application data is communicated, or delivered, to an eTV application server located at a cable headend. For example, the application and playlist may be delivered using Internet Protocols (IP) to an eTV application server. In one embodiment, the application data is first delivered to a centralized eTV application server, which may validate, regionalize and distribute the eTV application data to individual eTV application servers located at different cable headends, in advance of the program broadcast. Furthermore, in one embodiment, application data, playlists, and/or other data content may be updated at any time before the broadcast program.

At operation 36, the broadcast network communicates broadcast program scheduling information for an eTV application to the eTV application server at the cable headend. For example, in one embodiment, the network delivers the eTV schedule to a centralized eTV application server. The eTV schedule may be an XML file that describes the market, date/time, channel call letters and application identifier for each eTV application. The application resources and eTV schedule may be validated by the centralized eTV application server before redistribution across the cable network to the individual eTV application servers located at cable headends. Next, at operation 38, each headend eTV application server may include the scheduled program entries into the playlist directory prior to broadcast, and ensure that the playlist directory, application and its resources, and the playlist are available on the data carousel prior to the scheduled broadcast time.

In one embodiment, the eTV client-side application engine includes a “playlist listener” which, at operation 40, checks the playlist directory file on the carousel at a configurable frequency (e.g., every minute) for discovery of playlists that may be valid. When the valid window for a playlist occurs and the viewer is on the required broadcast channel at full screen viewing, the client-side application engine will auto-launch the playlist events, or alternatively display an “invitation” to engage the user in the interactivity of the playlist application. In one embodiment of the invention, the application and episode specific playlist are retrieved from the out-of-band broadcast data carousel to avoid any tune-away behaviors. Once the playlist application is active, the eTV client-side application engine is able to begin processing trigger events specified in the playlist file. In one embodiment, the scheduled execution time of each event is essentially an offset from the absolute scheduled start time of the broadcast program, and is usually specified in SMPTE time codes familiar to content producers.

Thus, a method is provided with reference to specific exemplary embodiments. It will be evident that various modifications and changes may be made to theses embodiments without departing from the broader spirit and scope of the invention. Accordingly, the specification and drawings are to be regarded in an illustrative rather than a restrictive sense.

What is claimed is:

1. A method comprising:
delivering to a server, in advance of a broadcast time of a program to be broadcast over a distribution network and using Internet protocol (IP), an eTV application for the program, a corresponding playlist for the eTV application and a programming schedule for the distribution network, the playlist specifying a list of events to be loaded by an application engine resident on a client device when executing the eTV application, the events of the playlist including identifiers that enable the eTV application to synchronize application trigger events to program events associated with the program;
prior to and during broadcast of the program according to the programming schedule, distributing a playlist directory, the eTV application and the playlist from the server to the client device independently from a broadcast stream including packets which make up the program; and
receiving the playlist directory, the eTV application and the playlist at the client device and, so long as the client device is tuned to the broadcast of the program associated with the eTV application, processing, by the application engine, the events as specified in the playlist.

2. The method of claim 1, wherein the playlist directory, the eTV application and the playlist are distributed from the server to the client device via upload to an out-of-band data carousel accessible by the client device independently from the broadcast stream including packets which make up the program.

3. The method of claim 1, wherein the playlist directory, the eTV application and the playlist are distributed from the server to the client device via IP multicast.

4. The method of claim 1, wherein the eTV application comprises an XML file.

5. The method of claim 4, wherein the XML file includes application layout information.

6. The method of claim 4, wherein the XML file includes application logic.

7. The method of claim 4, wherein the XML file includes image resources.

8. The method of claim 4, wherein the XML file includes program-specific information.

9. The method of claim 1, wherein the programming schedule describes a program market, date, time, channel and application identifier for the eTV application.

10. The method of claim 1, wherein prior to its uploading the programming schedule is validated.

11. The method of claim 1, wherein prior to its uploading the eTV application is validated.

12. The method of claim 1, wherein the events are processed at specified times according to offsets from a start time of the program.

13. The method of claim 1, wherein the specified times are specified in SMPTE time codes.

14. The method of claim 1, wherein the eTV application comprises a voting application.

15. The method of claim 1, wherein the eTV application comprises a polling application.

16. The method of claim 1, wherein the playlist comprises a list of application events scheduled to occur during broadcast of the program.

17. The method of claim 1, wherein at least one event of the playlist causes the application engine of the client device to display information.

18. The method of claim 1, wherein at least one event of the playlist causes the application engine of the client device to prompt a viewer to make a selection.

19. The method of claim 1, wherein the playlist comprises XML data.

20. The method of claim 1, wherein the programming schedule comprises and XML file.

21. The method of claim 18, wherein the XML file includes data relating to some or all of: market, time/date, channel call letters, and application identifiers.

22. The method of claim 1, wherein prior to its uploading the playlist directory is developed from the programming schedule.

23. The method of claim 1, wherein in response to a viewer input associated with one of the events of the playlist, communicating information associated with said response to the server.

24. The method of claim 21, wherein the viewer input comprises a selection from a list.

25. The method of claim 1, further comprising adjusting timing of playlist events in response to synchronization information received at the server.

26. The method of claim 1, wherein the eTV application, the playlist for the eTV application and the programming schedule are delivered to the server from a centralized eTV application server.

27. The method of claim 2, wherein the playlist directory, the eTV application and the playlist are recevied from the out-of-band carousel in response to an indication by a playlist listener associated with the application engine of the client device that the playlist is valid.

28. The method of claim 1, wherein the events specified in the playlist are processed by the application engine after a viewer has been invited to engage in interactivity offered by the eTV application.

29. An eTV application distribution system, comprising:
a server communicatively coupled to receive, in advance of a broadcast time of a program to be broadcast over a distribution network and using Internet protocol (IP), an eTV application for the program, a corresponding playlist for the eTV application and a programming schedule for the distribution network, the playlist specifying a list of events associated with the eTV application, which events include identifiers that enable the eTV application to synchronize application trigger events to program events associated with the program;
an out-of band data carousel communicatively coupled to receive from the server, and prior to broadcast of the program according to the programming schedule, a playlist directory, the eTV application and the playlist; and
a client device, communicatively coupled to receive, from the out-of-band data carousel and independently from a broadcast stream including packets which make up the program, the playlist directory, the eTV application and the playlist, the client device having an application engine configured to process the events specified in the playlist so long as the client device is tuned to the broadcast of the program associated with the eTV application.

30. The eTV application distribution system of claim 29, wherein the eTV application comprises an XML file.

31. The eTV application distribution system of claim 30, wherein the XML file includes application layout information.

32. The eTV application distribution system of claim 30, wherein the XML file includes application logic.

33. The eTV application distribution system of claim 30, wherein the XML file includes image resources.

34. The eTV application distribution system of claim 30, wherein the XML file includes program-specific information.

35. The eTV application distribution system of claim 29, wherein the programming schedule describes a program market, date, time, channel and application identifier for the eTV application.

36. The eTV application distribution system of claim 29, wherein the server is configured to validate the programming schedule prior to uploading the programming schedule to the out-of-band data carousel.

37. The eTV application distribution system of claim 29, wherein the server is configured to validate eTV application prior to uploading the eTV application to the out-of-band data carousel.

38. The eTV application distribution system of claim 29, wherein the eTV application comprises a voting application.

39. The eTV application distribution system of claim 29, wherein the eTV application comprises a polling application.

40. The eTV application distribution system of claim 29, wherein the playlist comprises a list of application events scheduled to occur during broadcast of the program.

41. The eTV application distribution system of claim 29, wherein the playlist comprises XML data.

42. The eTV application distribution system of claim 29, wherein the programming schedule comprises and XML file.

43. The eTV application distribution system of claim 42, wherein the XML file includes data relating to some or all of: market, time/date, channel call letters, and application identifiers.

44. An eTV application distribution system, comprising:
a server communicatively coupled to receive, in advance of a broadcast time of a program to be broadcast over a distribution network and using Internet protocol (IP), an eTV application for the program, a corresponding playlist for the eTV application and a programming schedule for the distribution network, the playlist specifying a list of events associated with the eTV application, which events include identifiers that enable the eTV application to synchronize application trigger events to program events associated with the program;
a client device, communicatively coupled to receive from the server, via IP multicast, prior to broadcast of the program according to the programming schedule, and independently from a broadcast stream including packets which make up the program, a playlist directory, an eTV application and the playlist, the client device having an application engine configured to process the events specified in the playlist so long as the client device is tuned to the broadcast of the program associated with the eTV application.

45. The eTV application distribution system of claim 44, wherein one or more of: the eTV application, the playlist and the programming schedule comprises an XML file.
